(19) United States
(12) Patent Application Publication
(10) Pub. No.: US 2026/0051937 A1
(43) Pub. Date: Feb. 19, 2026

(54) SUPPORT OF UE CENTRIC AI BASED TEMPORAL BEAM PREDICTION

(71) Applicant: LENOVO (BEIJING) LIMITED, Beijing (CN)

(72) Inventors: Bingchao Liu, Beijing (CN); Jianfeng Wang, Beijing (CN); Xin Guo, Beijing (CN); Haiming Wang, Beijing (CN)

(21) Appl. No.: 19/104,641

(22) PCT Filed: Aug. 19, 2022
(86) PCT No.: PCT/CN2022/113614

§ 371 Date: Feb. 18, 2025

(51) Int. Cl. H04B 7/06; H04B 17/318; H04L 41/16

(52) U.S. Cl. CPC H04B 7/0626; H04B 7/06952; H04B 17/328; H04L 41/16

(57) ABSTRACT

Methods and apparatuses for support of UE centric AI based temporal beam prediction are disclosed. In one embodiment, a UE comprises a transceiver; and a processor coupled to the transceiver, wherein the processor is configured to report, via the transceiver, a set of parameters to define each AI/ML Model that can be used for temporal beam prediction; and receive, via the transceiver, a configuration for CSI report setting for temporal beam prediction.

### FIELD

The subject matter disclosed herein generally relates to wireless communications, and more particularly relates to methods and apparatuses for support of UE centric AI based temporal beam prediction.

### BACKGROUND

The following abbreviations are herewith defined, at least some of which are referred to within the following description: New Radio (NR), Very Large Scale Integration (VLSI), Random Access Memory (RAM), Read-Only Memory (ROM), Erasable Programmable Read-Only Memory (EPROM or Flash Memory), Compact Disc Read-Only Memory (CD-ROM), Local Area Network (LAN), Wide Area Network (WAN), User Equipment (UE), Evolved Node B (CNB), Next Generation Node B (gNB), Uplink (UL), Downlink (DL), Central Processing Unit (CPU), Graphics Processing Unit (GPU), Field Programmable Gate Array (FPGA), Orthogonal Frequency Division Multiplexing (OFDM), Radio Resource Control (RRC), User Entity/Equipment (Mobile Terminal), Transmitter (TX), Receiver (RX), Machine learning (ML), artificial intelligence (AI), Deep Neural Network (DNN), Recurrent Neural Network (RNN), Reference Signal Receiving Power (RSRP), Layer 1 Reference Signal Receiving Power (L1-RSRP), Channel State Information (CSI), subcarrier space (SCS), Channel State Information Reference Signal (CSI-RS), CSI-RS resource indicator (CRI), synchronization signal (SS), Physical Broadcast Channel (PBCH), SS/PBCH Block (SSB), SSB resource indicator (SSBRI), cyclic prefix (CP), non-zero power (NZP), Bandwidth part (BWP).

Machine learning (ML) is a method to achieve artificial intelligence (AI). In the following description, they are described as AI/ML. AI/ML based beam prediction is studied in 3GPP NR Release 18 to enhance the system performance and/or to reduce beam management complexity and overhead. One potential use case is that an AI/ML function (which may also be referred to as “AI/ML inference function”) is deployed in a UE, and the UE can predict, by employing the AI/ML function, the best N (N>=1) beams for F (F>=1) future instances based on historical measurement results. The UE shall do the beam prediction based on network configuration (e.g. configuration from gNB) and report the beams for prediction to gNB.

This invention targets support of UE-centric AI based temporal beam prediction, such as necessary AI/ML related capability, and beam report related configuration.

### BRIEF SUMMARY

Methods and apparatuses for support of UE centric AI based temporal beam prediction are disclosed.

In one embodiment, a UE comprises a transceiver; and a processor coupled to the transceiver, wherein the processor is configured to report, via the transceiver, a set of parameters to define each AI/ML Model that can be used for temporal beam prediction; and receive, via the transceiver, a configuration for CSI report setting for temporal beam prediction.

In some embodiment, the parameters to define an AI/ML Model #i include: K_{M,i}, indicating the required measurement instances, F_{P,i}, indicating the maximum number of future instances for beam prediction, and Tᵢ, indicating the number of slots or symbols per SCS between two adjacent measurement instances and between two adjacent prediction instances to define K_{M,i} and F_{P,i}.

In some embodiment, the CSI reporting setting for temporal beam prediction includes: K_{M}, indicating the number of measurement instances for the measurement beams for AI/ML input, F_{P}, indicating the number of future instances for beam prediction, N_{F}, indicating the number of reported beams for each future instance, and T, indicating the number of slots or symbols between two adjacent measurement instances and between two adjacent prediction instances.

The time domain resource for CSI reference resources for the CSI reporting setting is defined by K_{M}×T continuous slots containing K_{M} transmissions of each CSI-RS resource. When an aperiodic NZP CSI-RS resource set is associated with an aperiodic CSI report for beam prediction, the CSI-RS resources within the NZP CSI-RS resource set are transmitted K_{M} times with a period of T beginning from a slot indicated by a DCI triggering the CSI-RS resources. The F_{P} future instances corresponding to F_{P}×T continuous slots begin from the slot for the UL transmission carrying beam report.

N_{F}×F_{P} beams are reported in the CSI report, where for each future instance, N_{F} best beams are reported. In particular, one beam group includes best N_{F} beams for one future instance, and for each beam group, RSRP is reported for the beam that has the largest predicted L1-RSRP value, and differential RSRP is reported for the other N_{F}−1 predicted beam(s). Alternatively, RSRP is reported for the beam that has the largest predicted L1-RSRP among all N_{F}×F_{P} beams for all future instances, and differential RSRP is reported for each of the other N_{F}×F_{P}−1 beams, and additional Index of the beam with largest RSRP field is contained in the CSI report to indicate the beam that has the largest predicted L1-RSRP.

In another embodiment, a method performed at a UE comprises reporting a set of parameters to define each AI/ML Model that can be used for temporal beam prediction; and receiving a configuration for CSI report setting for temporal beam prediction

In still another embodiment, a base unit comprises a transceiver; and a processor coupled to the transceiver, wherein the processor is configured to receive, via the transceiver, a set of parameters to define each AI/ML Model that can be used for temporal beam prediction; and transmit, via the transceiver, a configuration for CSI report setting for temporal beam prediction.

In some embodiment, the parameters to define an AI/ML Model #i include: K_{M,i}, indicating the required measurement instances, F_{P,i}, indicating the maximum number of future instances for beam prediction, and Tᵢ, indicating the number of slots or symbols per SCS between two adjacent measurement instances and between two adjacent prediction instances to define K_{M,i} and F_{P,i}.

In some embodiment, the CSI reporting setting for temporal beam prediction includes: K_{M}, indicating the number of measurement instances for the measurement beams for AI/ML input, F_{P}, indicating the number of future instances for beam prediction, N_{F}, indicating the number of reported beams for each future instance, and T, indicating the number of slots or symbols between two adjacent measurement instances and between two adjacent prediction instances.

The time domain resource for CSI reference resources for the CSI reporting setting is defined by K_{M}×T continuous slots containing K_{M} transmissions of each CSI-RS resource. When an aperiodic NZP CSI-RS resource set is associated with an aperiodic CSI report for beam prediction, the CSI-RS resources within the NZP CSI-RS resource set are transmitted K_{M} times with a period of T beginning from a slot indicated by a DCI triggering the CSI-RS resources. The F_{P} future instances corresponding to F_{P}×T continuous slots begin from the slot for the UL transmission carrying beam report.

N_{F}×F_{P} beams are reported in the CSI report, where for each future instance, N_{F}

best beams are reported. In particular, one beam group includes best N_{F} beams for one future instance, and for each beam group, RSRP is reported for the beam that has the largest predicted L1-RSRP value, and differential RSRP is reported for the other N_{F}−1 predicted beam(s).

Alternatively, RSRP is reported for the beam that has the largest predicted L1-RSRP among all N_{F}×F_{P} beams for all future instances, and differential RSRP is reported for each of the other N_{F}×F_{P}−1 beams, and additional Index of the beam with largest RSRP field is contained in the CSI report to indicate the beam that has the largest predicted L1-RSRP.

In yet another embodiment, a method performed at a base unit comprises receiving a set of parameters to define each AI/ML Model that can be used for temporal beam prediction; and transmitting a configuration for CSI report setting for temporal beam prediction

### BRIEF DESCRIPTION OF THE DRAWINGS

A more particular description of the embodiments briefly described above will be rendered by reference to specific embodiments that are illustrated in the appended drawings. Understanding that these drawings depict only some embodiments, and are not therefore to be considered to be limiting of scope, the embodiments will be described and explained with additional specificity and detail through the use of the accompanying drawings, in which:

FIG. 1 illustrates a first example of the AI/ML Model for temporal beam prediction.;

FIG. 2 illustrates a second example of AI/ML Model for temporal beam prediction;

FIG. 3 illustrates measurement instances and future instances;

FIG. 4 illustrates an example of CSI report configuration for beam prediction;

FIG. 5 is a schematic flow chart diagram illustrating an embodiment of a method;

FIG. 6 is a schematic flow chart diagram illustrating an embodiment of another method; and

FIG. 7 is a schematic block diagram illustrating apparatuses according to one embodiment.

### DETAILED DESCRIPTION

As will be appreciated by one skilled in the art that certain aspects of the embodiments may be embodied as a system, apparatus, method, or program product. Accordingly, embodiments may take the form of an entirely hardware embodiment, an entirely software embodiment (including firmware, resident software, micro-code, etc.) or an embodiment combining software and hardware aspects that may generally all be referred to herein as a “circuit”, “module” or “system”. Furthermore, embodiments may take the form of a program product embodied in one or more computer readable storage devices storing machine-readable code, computer readable code, and/or program code, referred to hereafter as “code”. The storage devices may be tangible, non-transitory, and/or non-transmission. The storage devices may not embody signals. In a certain embodiment, the storage devices only employ signals for accessing code.

Certain functional units described in this specification may be labeled as “modules”, in order to more particularly emphasize their independent implementation. For example, a module may be implemented as a hardware circuit comprising custom very-large-scale integration (VLSI) circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in code and/or software for execution by various types of processors. An identified module of code may, for instance, include one or more physical or logical blocks of executable code which may, for instance, be organized as an object, procedure, or function. Nevertheless, the executables of an identified module need not be physically located together, but, may include disparate instructions stored in different locations which, when joined logically together, include the module and achieve the stated purpose for the module.

Indeed, a module of code may contain a single instruction, or many instructions, and may even be distributed over several different code segments, among different programs, and across several memory devices. Similarly, operational data may be identified and illustrated herein within modules and may be embodied in any suitable form and organized within any suitable type of data structure. This operational data may be collected as a single data set, or may be distributed over different locations including over different computer readable storage devices. Where a module or portions of a module are implemented in software, the software portions are stored on one or more computer readable storage devices.

Any combination of one or more computer readable medium may be utilized. The computer readable medium may be a computer readable storage medium. The computer readable storage medium may be a storage device storing code. The storage device may be, for example, but need not necessarily be, an electronic, magnetic, optical, electromagnetic, infrared, holographic, micromechanical, or semiconductor system, apparatus, or device, or any suitable combination of the foregoing.

A non-exhaustive list of more specific examples of the storage device would include the following: an electrical connection having one or more wires, a portable computer diskette, a hard disk, random access memory (RAM), read-only memory (ROM), erasable programmable read-only memory (EPROM or Flash Memory), portable compact disc read-only memory (CD-ROM), an optical storage device, a magnetic storage device, or any suitable combination of the foregoing. In the context of this document, a computer-readable storage medium may be any tangible medium that can contain or store a program for use by or in connection with an instruction execution system, apparatus, or device.

Code for carrying out operations for embodiments may include any number of lines and may be written in any combination of one or more programming languages including an object-oriented programming language such as Python, Ruby, Java, Smalltalk, C++, or the like, and conventional procedural programming languages, such as the “C” programming language, or the like, and/or machine languages such as assembly languages. The code may be executed entirely on the user's computer, partly on the user's computer, as a stand-alone software package, partly on the user's computer and partly on a remote computer or entirely on the remote computer or server. In the very last scenario, the remote computer may be connected to the user's computer through any type of network, including a local area network (LAN) or a wide area network (WAN), or the connection may be made to an external computer (for example, through the Internet using an Internet Service Provider).

Reference throughout this specification to “one embodiment”, “an embodiment”, or similar language means that a particular feature, structure, or characteristic described in connection with the embodiment is included in at least one embodiment. Thus, appearances of the phrases “in one embodiment”, “in an embodiment”, and similar language throughout this specification may, but do not necessarily, all refer to the same embodiment, but mean “one or more but not all embodiments” unless expressly specified otherwise. The terms “including”, “comprising”, “having”, and variations thereof mean “including but are not limited to”, unless otherwise expressly specified. An enumerated listing of items does not imply that any or all of the items are mutually exclusive, otherwise unless expressly specified. The terms “a”, “an”, and “the” also refer to “one or more” unless otherwise expressly specified.

Furthermore, described features, structures, or characteristics of various embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid any obscuring of aspects of an embodiment.

Aspects of different embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code.

This code may be provided to a processor of a general purpose computer, special purpose computer, or other programmable data processing apparatus to produce a machine, such that the instructions, which are executed via the processor of the computer or other programmable data processing apparatus, create means for implementing the functions specified in the schematic flowchart diagrams and/or schematic block diagrams for the block or blocks.

The code may also be stored in a storage device that can direct a computer, other programmable data processing apparatus, or other devices, to function in a particular manner, such that the instructions stored in the storage device produce an article of manufacture including instructions which implement the function specified in the schematic flowchart diagrams and/or schematic block diagrams block or blocks.

The code may also be loaded onto a computer, other programmable data processing apparatus, or other devices, to cause a series of operational steps to be performed on the computer, other programmable apparatus or other devices to produce a computer implemented process such that the code executed on the computer or other programmable apparatus provides processes for implementing the functions specified in the flowchart and/or block diagram block or blocks.

The schematic flowchart diagrams and/or schematic block diagrams in the Figures illustrate the architecture, functionality, and operation of possible implementations of apparatuses, systems, methods and program products according to various embodiments. In this regard, each block in the schematic flowchart diagrams and/or schematic block diagrams may represent a module, segment, or portion of code, which includes one or more executable instructions of the code for implementing the specified logical function(s).

It should also be noted that in some alternative implementations, the functions noted in the block may occur out of the order noted in the Figures. For example, two blocks shown in succession may substantially be executed concurrently, or the blocks may sometimes be executed in the reverse order, depending upon the functionality involved. Other steps and methods may be conceived that are equivalent in function, logic, or effect to one or more blocks, or portions thereof, to the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each Figure may refer to elements of proceeding figures. Like numbers refer to like elements in all figures, including alternate embodiments of like elements.

As mentioned in the background part, an AI/ML Model in the UE that is used for temporal beam prediction performs beam quality prediction for F (F>=1) future instances based on the historical measurement results (e.g. on the latest K (K>=1) measurement instances) of the measurement beams by employing the time domain correlation. The AI/ML Model may be implemented by an RNN (Recurrent Neural Network) or DNN (Deep Neural Network) with a set of fixed weights, which can be updated with AI/ML Model update procedure. The detailed implementation of the AI/ML Model used for temporal beam prediction is out of the scope of this disclosure.

FIG. 1 illustrates a first example of the AI/ML Model for temporal beam prediction with AI/ML input and AI/ML output. A measurement beam set consists of a set of measurement beams. Each beam can be represented by a CSI-RS resource or a SSB resource. And the beam index can be represented by a CSI-RS resource index (CRI) or a SSB resource index (SSBRI). A prediction beam set consists of a set of beams for prediction. The input to the AI/ML Model is the historical (e.g. on measurement instances) beam measurement results (e.g. L1-RSRP) of the measurement beams within the measurement beam set. A measurement instance is a time instance at which the quality of each measurement beam is measured (or obtained). The output from the AI/ML mode is the predicted best N_{F}(N_{F}>=1) beams among the beams within the prediction beam set on F_{P} (F_{P}>=1) future instances. A future instance is a time instance that is after each of the measurement instances at which the beam measurement results are obtained. Each AI/ML Model requires a fixed input format (e.g. L1-RSRPs of a fixed number of measurement beams), and can output predicted best N beams (e.g. best N beams among the beams within the prediction beam set) for each of F (F<=F_{P}) future instances. A CSI report configuration which is configured by RRC parameter CSI-ReportConfig, i.e. a CSI reporting setting, for beam prediction shall be configured to satisfy the requirements of the AI/ML Model.

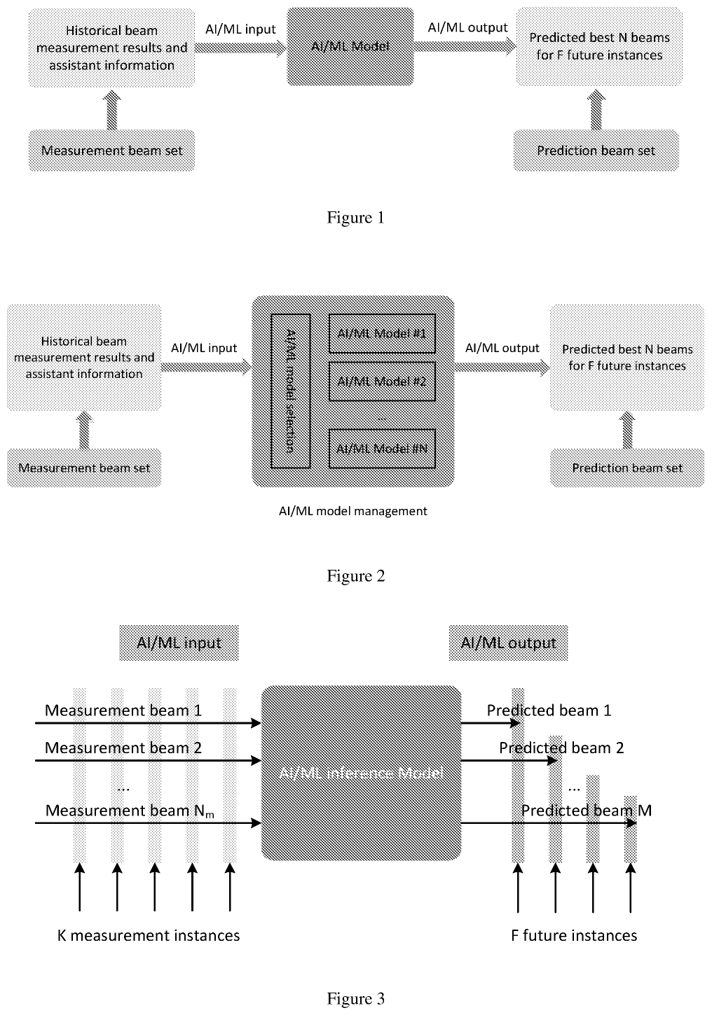

FIG. 2 illustrates a second example of AI/ML Model for temporal beam prediction, in which multiple AI/ML Models (e.g. AI/ML Model #1 to AI/ML Model #N) are provided in addition to an AI/ML Model selection function. The AI/ML Model selection function is used for selecting (allocating) an AI/ML Model from the multiple AI/ML Models for a certain beam prediction procedure. The multiple AI/ML Models and the AI/ML Model selection function can be collectively referred to as AI/ML Model management function.

When a CSI report configuration (i.e. CSI reporting setting) is configured for beam prediction, the AI/ML Model management function shall allocate (or select) an AI/ML Model for the CSI report configuration according to the AI/ML input and the required AI/ML output configured for the CSI report configuration. To ensure that the UE can allocate (or select) a proper AI/ML Model, the UE may need to report the supported AI/ML input and output formats for all the AI/ML Models supported by the UE. Based on the UE reported supported AI/ML input and output formats, the network side (e.g. gNB) can configure proper CSI report configurations for beam prediction.

A first embodiment relates to AI/ML related capability reporting.

For the UE supporting temporal beam prediction by AI/ML Model, when the UE reports or registers an AI/ML Model that can be used for temporal beam prediction, the UE needs to report the following parameters for the AI/ML Model for temporal beam prediction:
K_{M}: which indicates the number of required measurement instances for AI/ML Model input;
F_{P}: which indicates the maximum number of future instances for beam prediction; and
T: which indicates the granularity (e.g. the number of slots per SCS, which is configured per BWP of a cell (where each cell may comprise multiple BWPs each of which corresponds to a part of the bandwidth of the cell), or the number of symbols per SCS between two adjacent measurement instances and/or between two adjacent future instances) for an instance to define K_{M} and F_{P}. T_{M} indicates the granularity for the measurement instances, and T_{F} indicates the granularity for the future instances. In this disclosure, T_{M}=T_{F}=T.

The parameters for multiple AI/ML Models for temporal beam prediction that can be supported by the UE can be reported together. Table 1 provides an example of reporting AI/ML Models #1 to #N.

TABLE 1

| | Number of | Maximum number | Granularity of |
|---|---|---|---|
| | measurement | of future | instance |
| | instances for | instances for | (Number of slots |
| AI/ML | AI/ML Model | beam prediction | or symbols for a |
| Mode ID | input K_{M} | F_{P} | certain SCS) T |
| AI/ML | K_{M, 1} | F_{p, 1} | T₁ for SCS = 60 kHz |
| Model #1 | | | T₁ for SCS = 120 kHz |
| | | | T₁ for SCS = 480 kHz |
| | | | T₁ for SCS = 960 kHz |
| AI/ML | K_{M, 2} | F_{p, 2} | T₂ for SCS = 60 kHz |
| Model #2 | | | T₂ for SCS = 120 kHz |
| | | | T₂ for SCS = 480 kHz |
| | | | T₂ for SCS = 960 kHz |
| . . . | . . . | . . . | . . . |
| AI/ML | K_{M, N} | F_{p, N} | T_{N} for SCS = 60 kHz |
| Model #N | | | T_{N} for SCS = 120 kHz |
| | | | T_{N} for SCS = 480 kHz |
| | | | T_{N} for SCS = 960 kHz |

For example, when the UE is configured with a CSI reporting setting associated with AI/ML Model #2 for beam prediction, the UE should be configured with a set of measurement beams with K_{M,2} measurement instances. The UE can predict, by employing the AI/ML Model #2, the beam quality of the prediction beam set (e.g. L1-RSRPs of NF best beams within the prediction beam set) for F_{P,2} future instances, where each of the F_{P,2} future instances corresponds to T₂ slots for a certain SCS or the time duration between two adjacent instances is T₂ slots or T₂ symbols for a certain SCS.

For another AI/ML function deployment as illustrated in FIG. 2, the UE can report multiple sets of supported (K_{M}, F_{P}), e.g., (K_{M,0}, F_{P,0}), . . . , (K_{M,N}, F_{P,N}), based on a specific T value (suppose that T₁=T₂= . . . =T_{N}) for a certain SCS. When the gNB configures a CSI reporting setting for beam prediction with the number of measurement instances K_{M} and the number of future instances F_{P}, K_{M} and F_{P} shall satisfy at least one of (K_{M,i}, F_{P,i}) (i=1 to N) reported by the UE, in which K_{M} and F_{P} satisfy (K_{M,i}, F_{P,i}) means K_{M}=K_{M,i} and F_{P}<=F_{P,i}. The UE shall select a proper AI/ML Model for the CSI reporting setting from all AI/ML Models that (K_{M,i}, F_{P,i}) can be satisfied.

A second embodiment relates to CSI reference resources for a CSI report configured for temporal beam prediction.

The CSI reference resource set is defined as a set of time-frequency resources containing one or more CSI-RS resources or SSB resources for CSI computation including beam measurement and beam report. In the following description, CSI-RS resource or SSB resource is simplified as CSI-RS resource. In NR Release 17, a single slot (i.e. one slot) is determined for the UE to receive CSI-RS resource to calculate the reported CSI configured for the corresponding CSI report. Different from the NR Release 17 beam measurement and beam report configuration, when AI/ML model for temporal beam prediction is applied to predict beam qualities, multiple instances (e.g. multiple slots if one instance is one slot) are required for beam management with AI/ML capability as illustrated in FIG. 3.

To satisfy the required AI/ML input, the CSI reference resource set configuration should include multiple DL slots for the UE to obtain multiple measurement instances. Since different type of resources (e.g. periodic resource, semi-persistent resource and aperiodic resource) may be configured for different types of beam reports, the requirements are also different.

For periodic and semi-persistent CSI reporting for beam prediction, the time domain resource for CSI reference resource for a CSI reporting for beam prediction in UL slot n′ is defined by K_{M}×T_{M} continuous slots before slot

$$n - {n}_{CSI \_ ref} - {K}_{offset} \cdot \frac{{2}^{{μ}_{D L}}}{{2}^{{μ}_{{K}_{offset}}}} - 1$$

containing K_{M} instances each having a period of T_{M} DL slot(s), where the parameter n. K_{offset}, μ_{K}_{_{offset}} and μ_{DL} are defined in clause 5.2.2.5 of 3GPP TS38.214 V17.0.0, and n_{CSI_ref} is the smallest value greater than or equal to D·2^{μ}^{_{DL}} (where D is a positive integer) such that there are K_{M}×T_{M} continuous slots, within which there should be K_{M} transmissions for the beams configured in the measurement beam set (i.e. a set of CSI-RS resources). Incidentally, it is assumed that all CSI-RS resources within the measurement beam set are configured with the same periodicity.

For aperiodic CSI reporting for beam prediction associated with aperiodic CSI-RS resources, the triggered CSI-RS resources should be transmitted K_{M} times within K_{M}×T_{M} continuous DL slots with the following timing requirements (1)-(3):

(1) The CSI-RS triggering offset is defined from the slot in which the DCI triggering the CSI-RS resources is transmitted to the slot for the first transmission of the triggered CSI-RS resources (i.e. the first measurement instance).

(2) Each of the triggered CSI-RS resources (i.e. each CSI-RS resource within the measurement beam set) is transmitted K_{M} times with a period of T_{M} slots beginning from the slot (or referred to as the first slot) indicated by the triggering offset.

(3) The last transmission of the triggered CSI-RS resource should be received before

$$⌈ {Z}^{′} / {N}_{symb}^{slot} ⌉$$

slot(s) to the slot for the transmission of the associated CSI report containing the beams for prediction. It means that the AI/ML model needs at least

$$⌈ {Z}^{′} / {N}_{symb}^{slot} ⌉$$

slot(s) to complete the inference. Z′ is the number of symbols for the AI/ML model to complete the inference, and

$${N}_{symb}^{slot}$$

is the number of symbols per slot. ┌x┐ represents the smallest integer that is equal to or larger than x.

A third embodiment relates to CSI report for beam prediction.

An example of CSI report configuration for beam prediction is provided in Table 2.

TABLE 2

| | |
|---|---|
| CSI-ReportConfig::={ | |
| resourcesForBeamPrediction | NZP-CSI-RS-ResourceSet |
| resourcesForBeamMeasurement | NZP-CSI-RS-ResourceSet |
| Number of measurement Instances for AI/ML input | K_{M} |
| Number of future instances for beam prediction | F_{P} |
| Number of reported beams for each future instance | N_{F} |
| Number of slots for each instance | T |
| } | |

resourcesForBeamPrediction indicates an NZP-CSI-RS-ResourceSet containing multiple NZP CSI-RS resources for beam prediction (i.e. measurement beams within the beam measurement set).

resourcesForBeamMeasurement indicates an NZP-CSI-RS-ResourceSet containing multiple NZP CSI-RS resources for beam measurement (i.e. beams within the beam prediction set).

K_{M} indicates the number of measurement instances for the measurement beams for AI/ML input.

F_{P} indicates the number of future instances for beam prediction.

N_{F} indicates the number of reported beams for each future instance. The reported beams for one future instance are the best beams (e.g. with the largest predicted L1-RSRP values) among the beams within the beam prediction set. The total number of reported beams for a beam report (i.e. for F_{P} future instances) is N_{F}×F_{P}.

T indicates the number of slots between two adjacent instances for the CSI report. It is assumed that both the number of slots for a measurement instance (T_{M}) and the number of slots for a future instance (T_{F}) are equal to T.

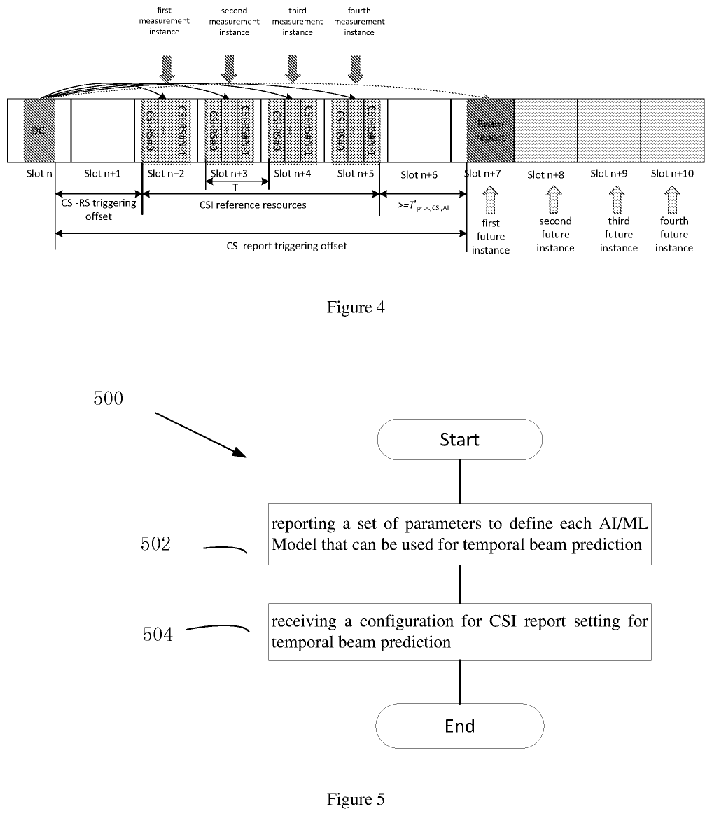

FIG. 4 illustrates an example of CSI report configuration for beam prediction.

The beam prediction set consists of CSI-RS #0 to CSI-RS #N−1. Each CSI-RS corresponds to a measurement beam.

The number of measurement instances for AI/ML input (K_{M}) is 4 (e.g. a first measurement instance, a second measurement instance, a third measurement instance and a fourth measurement instance).

The number of future instances for beam prediction (F_{P}) is 4 (e.g. a first future instance, a second future instance, a third future instance and a fourth future instance).

The number of reported beams for each future instance is N_{F} (not shown in FIG. 4).

The number of slots for each instance (T) is 1 slot. It means that the duration between two adjacent instances (e.g. between two adjacent measurement instances, and between two adjacent future instances) is 1 slot (i.e. T_{M}=T_{F}=1 slot).

The first CSI-RS transmission slot is the slot indicated by the CSI-RS triggering offset indicated in the DCI (e.g. triggering offset=2 slots, counting from the slot in which DCI is received (i.e. slot n), that is slot n+2 in FIG. 4).

Since K_{M}=4, the triggered CSI-RS resources (i.e. within the measurement beam set) should be repeated 4 times with a period of 1 slot (=T=T_{M}).

The time duration between the last symbol of the last CSI-RS transmission and the first symbol for the beam report should be equal to or larger than the CSI computation time T′_{proc,CSI,AI}, where, T′_{proc,CSI,AI} is defined as the next UL symbol with its CP starting T′_{proc,CSI,AI} after the end of the last symbol in time of aperiodic CSI-RS for channel measurement when aperiodic CSI-RS is used for channel measurement for the triggered CSI report containing beam report corresponding to an AI/ML based beam prediction.

The future instances are defined from the slot (or the first slot) on which the beam report is sent (e.g. slot n+7 in FIG. 4). The first slot on which the beam report is sent is counted from the slot in which DCI is received, calculated by a sum of CSI-RS triggering offset, K_{M}×T (i.e. the duration for transmission of the CSI reference resources (i.e. measurement beams) for K_{M} times, and

$$⌈ {Z}^{′} / {N}_{symb}^{slot} ⌉$$

(corresponding to the C′SI computation time). Since N_{F}=4 (and T_{F}=T=1 slot), the first future instance, the second future instance, the third future instance and the fourth future instance are slots n+7, n+8, n+9 and n+10, respectively.

A fourth embodiment relates to reporting N_{F}×F_{P} beams in a CSI report.

A first sub-embodiment of the fourth embodiment relates to differential RSRP based report for each beam group corresponding to a future instance.

A beam group is defined as consisting of the beams to be reported on one future instance. In other words, one beam group consists of NF beams for one future instance. Each beam is indicated by a CRI or SSBRI. A L1-RSRP (abbreviated as “RSRP” hereinafter) is predicted for each of N_{F} beams within the beam prediction set on the one future instance. Among the beams within the beam prediction set, N_{F} best beams (it means that N_{F} beams have the largest predicted NF L1-RSRPs) among the prediction beam set are selected as the reported N_{F} beams for the one future instance. The NF best beams are indicated by N_{F} CRIs or SSBRIs (e.g. CRI or SSBRI #1, CRI or SSBRI #2, and CRI or SSBRI #N_{F} in Table 3 or Table 4), in which the best of the N_{F} best beams is indicated by CRI or SSBRI #1. It means that CRI or SSBRI #1 indicates the beam with the largest predicted RSRP value among the N_{F} reported beams. The largest predicted RSRP value (which is indicated by CRI or SSBRI #1) for the one future instance is quantized to a 7-bit value in range of [−140, −44] dBm with 1 dB step size (i.e. RSRP of CRI or SSBRI #1). For each of the other NF−1 reported predicted RSRP values for the one future instance, a differential RSRP (i.e. differential RSRP of CRI or SSBRIs #2 to #NF) is computed with 2 dB step size with a reference to the largest predicted RSRP value (i.e. RSRP of CRI or SSBRI #1). The differential RSRP is quantized to a 4-bit value.

Table 3 gives an example of a CSI report according to the first sub-embodiment of the fourth embodiment.

TABLE 3

| CSI report number | CSI fields |
|---|---|
| CSI report #n | CRI or SSBRI #1 for the first future instance |
| | CRI or SSBRI #2 for the first future instance |
| | . . . |
| | CRI or SSBRI #N_{F} for the first future instance |
| | RSRP of CRI or SSBRI #1 for the first future |
| | instance |
| | Differential RSRP of CRI or SSBRI #2 for the |
| | first future instance |
| | . . . |
| | Differential RSRP of CRI or SSBRI #N_{F} for the |
| | first future instance |
| | . . . |
| | CRI or SSBRI #1 for the F_{P}^{th} future instance |
| | CRI or SSBRI #2 for the F_{P}^{th} future instance |
| | . . . |
| | CRI or SSBRI #N_{F} for the F_{P}^{th} future instance |
| | RSRP of CRI or SSBRI #1 for the F_{P}^{th} future |
| | instance |
| | Differential RSRP of CRI or SSBRI #2 for the |
| | F_{P}^{th} future instance |
| | . . . |
| | Differential RSRP of CRI or SSBRI #N_{F} for the |
| | Fₚ^{th} future instance |

Table 4 gives another example of a CSI report according to the first sub-embodiment of the fourth embodiment, which has the same CSI fields as Table 3 except that the sequence of the CSI fields are different.

TABLE 4

| CSI report number | CSI fields |
|---|---|
| CSI report #n | CRI or SSBRI #1 for the first future instance |
| | CRI or SSBRI #2 for the first future instance |
| | . . . |
| | CRI or SSBRI #N_{F} for the first future instance |
| | . . . |
| | CRI or SSBRI #1 for the F_{P}^{th} future instance |
| | CRI or SSBRI #2 for the F_{P}^{th} future instance |
| | . . . |
| | CRI or SSBRI #N_{F} for the F_{P}^{th} future instance |
| | RSRP of CRI or SSBRI #1 for the first future |
| | instance |
| | Differential RSRP of CRI or SSBRI #2 for the |
| | first future instance |
| | . . . |
| | Differential RSRP of CRI or SSBRI #N_{F} for the |
| | first future instance |
| | . . . |
| | RSRP of CRI or SSBRI #1 for the F_{P}^{th} future |
| | instance |
| | Differential RSRP of CRI or SSBRI #2 for the |
| | F_{P}^{th} future instance |
| | . . . |
| | Differential RSRP of CRI or SSBRI #N_{F} for the |
| | F_{P}^{th} future instance |

In Table 3, the CRIs or SSBRIs for the first future instance are followed by the RSRP and differential RSRPs of the CRIs or SSBRIs for the first future instance, and then followed by CRIs or SSBRIs for the next future instance and RSRP and differential RSRPs of the CRIs or SSBRIs for the next future instance, until the last future instance.

In Table 4, the CRIs or SSBRIs for the first future instance are followed by CRIs or SSBRIs for the next future instance until the last future instance, and then followed by the RSRP and differential RSRPs of the CRIs or SSBRIs for the first future instance until for the last future instance.

A second sub-embodiment of the fourth embodiment relates to differential RSRP based report for all beam groups (or for all reported beams) on all future instances.

To further reduce the overhead of the CSI report, only the largest predicted RSRP value among all reported beams for all future instances is quantized to a 7-bit value in range of [−140, −44] dBm with 1 dB step size. For each the other N_{F}×F_{P-1} predicted RSRP values, a differential RSRP is computed with 2 dB step size with a reference to the largest predicted RSRP value, and is quantized to a 4-bit value. To indicate the beam with largest predicted RSRP, an additional Index of the beam with largest RSRP field is introduced in the CSI report to indicate the beam that has the largest measured RSRP.

Table 5 gives an example of a CSI report according to the second sub-embodiment of the fourth embodiment.

TABLE 5

| CSI report | |
|---|---|
| number | CSI fields |
| CSI report #n | Index of the beam with largest RSRP |
| | CRI or SSBRI #1 for the first future instance |
| | CRI or SSBRI #2 for the first future instance |
| | . . . |
| | CRI or SSBRI #N_{F} for the first future instance |
| | . . . |
| | CRI or SSBRI #1 for the F_{P}^{th} future instance |
| | CRI or SSBRI #2 for the F_{P}^{th} future instance |
| | . . . |
| | CRI or SSBRI #N_{F} for the F_{P}^{th} future instance |
| | Differential RSRP or RSRP of CRI or SSBRI #1 |
| | for the first future instance |
| | Differential RSRP or RSRP of CRI or SSBRI #2 |
| | for the first future instance |
| | . . . |
| | Differential RSRP or RSRP of CRI or SSBRI #N_{F} |
| | for the first future instance |
| | . . . |
| | Differential RSRP or RSRP of CRI or SSBRI #1 |
| | for the F_{P}^{th} future instance |
| | Differential RSRP or RSRP of CRI or SSBRI #2 |
| | for the F_{P}^{th} future instance |
| | . . . |
| | Differential RSRP or RSRP of CRI or SSBRI #N_{F} |
| | for the F_{P}^{th} future instance |

In Table 5, the Index of the beam with largest RSRP field may have a bit width of [log₂(N_{F}×F_{P})]. So, the Index of the beam with largest RSRP field may indicate one CRI or SSBRI that has the largest predicted RSRP value among N_{F}×F_{P} CRIs or SSBRIs. Alternatively, the Index of the beam with largest RSRP field may have a bit width of [log₂(F_{P})] in view of the fact that each of CRI or SSBRI #1 for each future instance has the largest predicted RSRP value among CRIs or SSBRIs for each future instance. It means that the Index of the beam with largest RSRP field may indicate one CRI or SSBRI #1 that has the largest predicted RSRP value among F_{P} CRIs or SSBRIs #1.

Among the N_{F}×F_{P} differential RSRP or RSRP fields, only one that is indicated by the Index of the beam with largest RSRP field has RSRP value with 7 bits, and all of the others have differential RSRP values each with 4 bits.

FIG. 5 is a schematic flow chart diagram illustrating an embodiment of a method 500 according to the present application. In some embodiments, the method 500 is performed by an apparatus, such as a remote unit (e.g. UE). In certain embodiments, the method 500 may be performed by a processor executing program code, for example, a microcontroller, a microprocessor, a CPU, a GPU, an auxiliary processing unit, a FPGA, or the like.

The method 500 is a method performed at a UE, comprising: 502 reporting a set of parameters to define each AI/ML Model that can be used for temporal beam prediction; and 504 receiving a configuration for CSI report setting for temporal beam prediction.

In some embodiment, the parameters to define an AI/ML Model #i include: K_{M,i}, indicating the required measurement instances, F_{P,i}, indicating the maximum number of future instances for beam prediction, and Tᵢ, indicating the number of slots or symbols per SCS between two adjacent measurement instances and between two adjacent prediction instances to define K_{M,i} and F_{P,i}.

In some embodiment, the CSI reporting setting for temporal beam prediction includes: K_{M}, indicating the number of measurement instances for the measurement beams for AI/ML input, F_{P}, indicating the number of future instances for beam prediction, N_{F}, indicating the number of reported beams for each future instance, and T, indicating the number of slots or symbols between two adjacent measurement instances and between two adjacent prediction instances.

The time domain resource for CSI reference resources for the CSI reporting setting is defined by K_{M}×T continuous slots containing K_{M} transmissions of each CSI-RS resource. When an aperiodic NZP CSI-RS resource set is associated with an aperiodic CSI report for beam prediction, the CSI-RS resources within the NZP CSI-RS resource set are transmitted K_{M} times with a period of T beginning from a slot indicated by a DCI triggering the CSI-RS resources. The F_{P} future instances corresponding to F_{P}×T continuous slots begin from the slot for the UL transmission carrying beam report.

N_{F}×F_{P} beams are reported in the CSI report, where for each future instance, N_{F} best beams are reported. In particular, one beam group includes best N_{F} beams for one future instance, and for each beam group, RSRP is reported for the beam that has the largest predicted L1-RSRP value, and differential RSRP is reported for the other N_{F}−1 predicted beam(s). Alternatively, RSRP is reported for the beam that has the largest predicted L1-RSRP among all N_{F}×F_{P} beams for all future instances, and differential RSRP is reported for each of the other N_{F}×F_{P}−1 beams, and additional Index of the beam with largest RSRP field is contained in the CSI report to indicate the beam that has the largest predicted L1-RSRP.

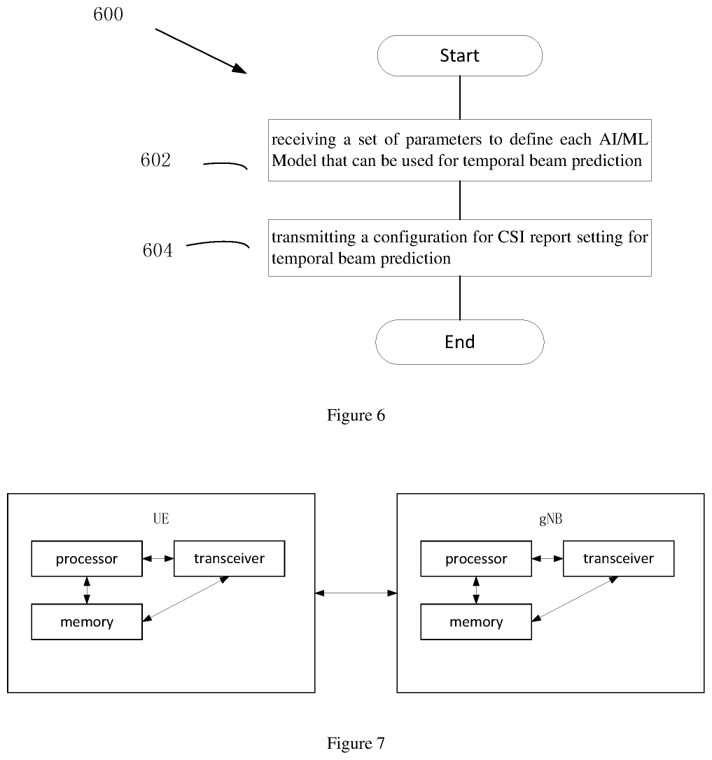

FIG. 6 is a schematic flow chart diagram illustrating an embodiment of a method 600 according to the present application. In some embodiments, the method 600 is performed by an apparatus, such as a base unit. In certain embodiments, the method 600 may be performed by a processor executing program code, for example, a microcontroller, a microprocessor, a CPU, a GPU, an auxiliary processing unit, a FPGA, or the like.

The method 600 may comprise 602 receiving a set of parameters to define each AI/ML Model that can be used for temporal beam prediction; and 604 transmitting a configuration for CSI report setting for temporal beam prediction.

In some embodiment, the parameters to define an AI/ML Model #i include: K_{M,i}, indicating the required measurement instances, F_{P,i}, indicating the maximum number of future instances for beam prediction, and Tᵢ, indicating the number of slots or symbols per SCS between two adjacent measurement instances and between two adjacent prediction instances to define K_{M,i} and F_{P,i}.

In some embodiment, the CSI reporting setting for temporal beam prediction includes: K_{M}, indicating the number of measurement instances for the measurement beams for AI/ML input, F_{P}, indicating the number of future instances for beam prediction, N_{F}, indicating the number of reported beams for each future instance, and T, indicating the number of slots or symbols between two adjacent measurement instances and between two adjacent prediction instances.

The time domain resource for CSI reference resources for the CSI reporting setting is defined by K_{M}×T continuous slots containing K_{M} transmissions of each CSI-RS resource. When an aperiodic NZP CSI-RS resource set is associated with an aperiodic CSI report for beam prediction, the CSI-RS resources within the NZP CSI-RS resource set are transmitted K_{M} times with a period of T beginning from a slot indicated by a DCI triggering the CSI-RS resources. The F_{P} future instances corresponding to F_{P}×T continuous slots begin from the slot for the UL transmission carrying beam report.

N_{F}×F_{P} beams are reported in the CSI report, where for each future instance, N_{F} best beams are reported. In particular, one beam group includes best N_{F} beams for one future instance, and for each beam group, RSRP is reported for the beam that has the largest predicted L1-RSRP value, and differential RSRP is reported for the other N_{F}−1 predicted beam(s). Alternatively, RSRP is reported for the beam that has the largest predicted L1-RSRP among all N_{F}×F_{P} beams for all future instances, and differential RSRP is reported for each of the other N_{F}×F_{P}−1 beams, and additional Index of the beam with largest RSRP field is contained in the CSI report to indicate the beam that has the largest predicted L1-RSRP.

FIG. 7 is a schematic block diagram illustrating apparatuses according to one embodiment.

Referring to FIG. 7, the UE (i.e. the remote unit) includes a processor, a memory, and a transceiver. The processor implements a function, a process, and/or a method which are proposed in FIG. 5.

The UE comprises a transceiver; and a processor coupled to the transceiver, wherein the processor is configured to report, via the transceiver, a set of parameters to define each AI/ML Model that can be used for temporal beam prediction; and receive, via the transceiver, a configuration for CSI report setting for temporal beam prediction.

In some embodiment, the parameters to define an AI/ML Model #i include: K_{M,i}. indicating the required measurement instances, F_{P,i}, indicating the maximum number of future instances for beam prediction, and Tᵢ, indicating the number of slots or symbols per SCS between two adjacent measurement instances and between two adjacent prediction instances to define K_{M,i} and F_{P,i}.

In some embodiment, the CSI reporting setting for temporal beam prediction includes: K_{M}, indicating the number of measurement instances for the measurement beams for AI/ML input, F_{P}, indicating the number of future instances for beam prediction, N_{F}, indicating the number of reported beams for each future instance, and T, indicating the number of slots or symbols between two adjacent measurement instances and between two adjacent prediction instances.

The time domain resource for CSI reference resources for the CSI reporting setting is defined by K_{M}×T continuous slots containing K_{M} transmissions of each CSI-RS resource. When an aperiodic NZP CSI-RS resource set is associated with an aperiodic CSI report for beam prediction, the CSI-RS resources within the NZP CSI-RS resource set are transmitted K_{M} times with a period of T beginning from a slot indicated by a DCI triggering the CSI-RS resources. The F_{P} future instances corresponding to F_{P}×T continuous slots begin from the slot for the UL transmission carrying beam report.

N_{F}×F_{P} beams are reported in the CSI report, where for each future instance, N_{F} best beams are reported. In particular, one beam group includes best N_{F} beams for one future instance, and for each beam group, RSRP is reported for the beam that has the largest predicted L1-RSRP value, and differential RSRP is reported for the other N_{F}−1 predicted beam(s). Alternatively, RSRP is reported for the beam that has the largest predicted L1-RSRP among all N_{F}×F_{P} beams for all future instances, and differential RSRP is reported for each of the other N_{F}×F_{P-1} beams, and additional Index of the beam with largest RSRP field is contained in the CSI report to indicate the beam that has the largest predicted L1-RSRP.

The gNB (i.e. the base unit) includes a processor, a memory, and a transceiver. The processor implements a function, a process, and/or a method which are proposed in FIG. 6.

The base unit comprises a transceiver; and a processor coupled to the transceiver, wherein the processor is configured to receive, via the transceiver, a set of parameters to define each AI/ML Model that can be used for temporal beam prediction; and transmit, via the transceiver, a configuration for CSI report setting for temporal beam prediction.

In some embodiment, the parameters to define an AI/ML Model #i include: K_{M,i}, indicating the required measurement instances, F_{P,i}, indicating the maximum number of future instances for beam prediction, and Tᵢ, indicating the number of slots or symbols per SCS between two adjacent measurement instances and between two adjacent prediction instances to define K_{M,i} and F_{P,i}.

In some embodiment, the CSI reporting setting for temporal beam prediction includes: K_{M}, indicating the number of measurement instances for the measurement beams for AI/ML input, F_{P}, indicating the number of future instances for beam prediction, N_{F}, indicating the number of reported beams for each future instance, and T, indicating the number of slots or symbols between two adjacent measurement instances and between two adjacent prediction instances.

The time domain resource for CSI reference resources for the CSI reporting setting is defined by K_{M}×T continuous slots containing K_{M} transmissions of each CSI-RS resource. When an aperiodic NZP CSI-RS resource set is associated with an aperiodic CSI report for beam prediction, the CSI-RS resources within the NZP CSI-RS resource set are transmitted K_{M} times with a period of T beginning from a slot indicated by a DCI triggering the CSI-RS resources. The F_{P} future instances corresponding to F_{P}×T continuous slots begin from the slot for the UL transmission carrying beam report.

N_{F}×F_{P} beams are reported in the CSI report, where for each future instance, N_{F} best beams are reported. In particular, one beam group includes best N_{F} beams for one future instance, and for each beam group, RSRP is reported for the beam that has the largest predicted L1-RSRP value, and differential RSRP is reported for the other N_{F}−1 predicted beam(s). Alternatively, RSRP is reported for the beam that has the largest predicted L1-RSRP among all N_{F}×F_{P} beams for all future instances, and differential RSRP is reported for each of the other N_{F}×F_{P}−1 beams, and additional Index of the beam with largest RSRP field is contained in the CSI report to indicate the beam that has the largest predicted L1-RSRP.

Layers of a radio interface protocol may be implemented by the processors. The

memories are connected with the processors to store various pieces of information for driving the processors. The transceivers are connected with the processors to transmit and/or receive a radio signal. Needless to say, the transceiver may be implemented as a transmitter to transmit the radio signal and a receiver to receive the radio signal.

The memories may be positioned inside or outside the processors and connected

with the processors by various well-known means.

In the embodiments described above, the components and the features of the embodiments are combined in a predetermined form. Each component or feature should be considered as an option unless otherwise expressly stated. Each component or feature may be implemented not to be associated with other components or features. Further, the embodiment may be configured by associating some components and/or features. The order of the operations described in the embodiments may be changed. Some components or features of any embodiment may be included in another embodiment or replaced with the component and the feature corresponding to another embodiment. It is apparent that the claims that are not expressly cited in the claims are combined to form an embodiment or be included in a new claim.

The embodiments may be implemented by hardware, firmware, software, or combinations thereof. In the case of implementation by hardware, according to hardware implementation, the exemplary embodiment described herein may be implemented by using one or more application-specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, and the like.

Embodiments may be practiced in other specific forms. The described embodiments are to be considered in all respects to be only illustrative and not restrictive. The scope of the invention is, therefore, indicated in the appended claims rather than by the foregoing description. All changes which come within the meaning and range of equivalency of the claims are to be embraced within their scope.

1. A user equipment (UE), comprising:
at least one memory; and
at least one processor coupled with the at least one memory and configured to cause the UE to:
report a set of parameters to define each artificial intelligence (AI)/machine learning (ML) Model that can be used for temporal beam prediction; and
receive a configuration for channel state information (CSI) report setting for temporal beam prediction.

2. The UE of claim 1, wherein, the parameters to define an AI/ML Model #i include:
K_{M,i}, indicating a required measurement instances,
F_{P,i}, indicating the maximum number of future instances for beam prediction, and
Tᵢ, indicating the number of slots or symbols per SCS between two adjacent measurement instances and between two adjacent prediction instances to define K_{M,i} and F_{P,i}.

3. The UE of claim 1, wherein, the CSI reporting setting for temporal beam prediction includes:
K_{M}, indicating a number of measurement instances for measurement beams for AI/ML input,
F_{P}, indicating a number of future instances for beam prediction,
N_{F}, indicating a number of reported beams for each future instance, and
T, indicating a number of slots or symbols between two adjacent measurement instances and between two adjacent prediction instances.

4. The UE of claim 3, wherein, a time domain resource for CSI reference resources for the CSI reporting setting is defined by K_{M}×T continuous slots containing K_{M} transmissions of each CSI-reference signal (RS) resource.

5. The UE of claim 3, wherein, when an aperiodic non-zero power (NZP) CSI-reference signal (RS) resource set is associated with an aperiodic CSI report for beam prediction, the CSI-RS resources within the NZP CSI-RS resource set are transmitted K_{M} times with a period of T beginning from a slot indicated by a downlink control information (DCI) triggering the CSI-RS resources.

6. The UE of claim 3, wherein, F_{P} future instances corresponding to F_{P}×T continuous slots begin from the slot for an uplink (UL) transmission carrying beam report.

7. The UE of claim 3, wherein, N_{F}×F_{P} beams are reported in the CSI report, where for each future instance, N_{F} best beams are reported.

8. The UE of claim 7, wherein,
one beam group includes best N_{F} beams for one future instance, and for each beam group, reference signal received power (RSRP) is reported for the beam that has the largest predicted layer 1 (L1)-RSRP value, and differential RSRP is reported for the other N_{F}−1 predicted beam(s).

9. The UE of claim 7, wherein,
reference signal received power (RSRP) is reported for the beam that has the largest predicted layer 1 (L1)-RSRP among all N_{F}×F_{P} beams for all future instances, and differential RSRP is reported for each of the other N_{F}×F_{P}−1 beams, and
additional Index of the beam with largest RSRP field is contained in the CSI report to indicate the beam that has the largest predicted L1-RSRP.

10. A method performed at a user equipment (UE), comprising:
reporting a set of parameters to define each artificial intelligence (AI)/machine learning (ML) Model that can be used for temporal beam prediction; and
receiving a configuration for channel state information (CSI) report setting for temporal beam prediction.

11. A base station unit, comprising:
at least one memory; and
at least one processor coupled with the at least one memory and configured to cause the base station to:
receive a set of parameters to define each artificial intelligence (AI)/machine learning (ML) Model that can be used for temporal beam prediction; and
transmit a configuration for channel state information (CSI) report setting for temporal beam prediction.

12. A processor for wireless communication, comprising:
at least one controller coupled with at least one memory and configured to cause the processor to:
report a set of parameters to define each artificial intelligence (AI)/machine learning (ML) Model that can be used for temporal beam prediction; and
receive a configuration for channel state information (CSI) report setting for temporal beam prediction.

13. The processor of claim 12, wherein, the parameters to define an AI/ML Model #i include:
K_{M,i}, indicating a required measurement instances,
F_{P,i}, indicating the maximum number of future instances for beam prediction, and
Tᵢ, indicating the number of slots or symbols per SCS between two adjacent measurement instances and between two adjacent prediction instances to define K_{M,i} and F_{P,i}.

14. The processor of claim 12, wherein, the CSI reporting setting for temporal beam prediction includes:
K_{M}, indicating a number of measurement instances for measurement beams for AI/ML input,
F_{P}, indicating a number of future instances for beam prediction,
N_{F}, indicating a number of reported beams for each future instance, and
T, indicating a number of slots or symbols between two adjacent measurement instances and between two adjacent prediction instances.

15. The processor of claim 14, wherein, a time domain resource for CSI reference resources for the CSI reporting setting is defined by K_{M}×T continuous slots containing K_{M} transmissions of each CSI-reference signal (RS) resource.

16. The processor of claim 14, wherein, when an aperiodic non-zero power (NZP) CSI-reference signal (RS) resource set is associated with an aperiodic CSI report for beam prediction, the CSI-RS resources within the NZP CSI-RS resource set are transmitted K_{M} times with a period of T beginning from a slot indicated by a downlink control information (DCI) triggering the CSI-RS resources.

17. The processor of claim 14, wherein, F_{P} future instances corresponding to F_{P}×T continuous slots begin from the slot for an uplink (UL) transmission carrying beam report.

18. The processor of claim 14, wherein, N_{F}×F_{P} beams are reported in the CSI report, where for each future instance, N_{F} best beams are reported.

19. The processor of claim 18, wherein,
one beam group includes best N_{F} beams for one future instance, and
for each beam group, reference signal received power (RSRP) is reported for the beam that has the largest predicted layer 1 (L1)-RSRP value, and differential RSRP is reported for the other N_{F}−1 predicted beam(s).

20. The processor of claim 18, wherein, reference signal received power (RSRP) is reported for the beam that has the largest predicted layer 1 (L1)-RSRP among all N_{F}×F_{P} beams for all future instances, and differential RSRP is reported for each of the other N_{F}×F−1 beams, and additional Index of the beam with largest RSRP field is contained in the CSI report to indicate the beam that has the largest predicted L1-RSRP.
